(19) United States
(12) Patent Application Publication
(10) Pub. No.: US 2012/0303844 A1
(43) Pub. Date: Nov. 29, 2012

(54) CONTROLLER AND CONTROLLING METHOD THEREOF

(75) Inventor: Wae-Chih Lin, Taipei (TW)

(73) Assignee: ASUSTek COMPUTER INC., Taipei (TW)

(21) Appl. No.: 13/465,151

(22) Filed: May 7, 2012

(30) Foreign Application Priority Data
May 27, 2011 (TW) 100118707

(51) Int. Cl. G06F 3/00

(52) U.S. Cl. 710/52

(57) ABSTRACT

A controller includes a first input port, a first buffering unit, a timer, and a package processing unit. When a first byte from the first input device is received by the first buffering unit, the timer starts counting time. If a second byte from the first input device is received by the first buffering unit during a preset time interval, the timer re-counts time. Whereas, if no second byte from the first input device is received by the first buffering unit during the preset time interval, the timer issues a time out signal. In response to the time out signal, all bytes in the first buffering unit are packed into a first packet by the package processing unit and an interrupt request is issues to a controlling circuit.

This application claims the benefit of Taiwan Patent Application No. 100118707, filed May 27, 2011, the subject matter of which is incorporated herein by reference.

### FIELD OF THE INVENTION

The present invention relates to a controller and a controlling method thereof, and more particularly to a PS/2 controller and a controlling method thereof.

### BACKGROUND OF THE INVENTION

FIG. 1 is a schematic functional block diagram illustrating the architecture of a conventional computer system. As shown in FIG. 1, the conventional computer system 100 comprises a central processing unit (CPU) 110, a control chipset 120, a memory 130, a hard disc 140, and a PS/2 controller 150. The control chipset 120 comprises a north bridge chip 122 and a south bridge chip 126.

The central processing unit 110 is in communication with the north bridge chip 122 through a front side bus. The north bridge chip 122 is in communication with the memory 130 through a memory bus. The south bridge chip 126 is in communication with the north bridge chip 122 through a private bus. For example, the private bus is a direct media interface (DMI) bus. In addition, the south bridge chip 126 is in communication with the PS/2 controller 150 through a low pin count bus (also referred as a LPC bus).

Generally, in response to an action of a PS/2 device, the PS/2 device generates a data. For different types of PS/2 devices, the data sizes are usually different. For example, when the same button action is performed, different type of PS/2 mouse devices may generate data of different sizes. The data size is usually in the range between 4 bytes and 8 bytes. After the data from the PS/2 device is received by the PS/2 controller 150, the data will be transmitted to the south bridge chip 126.

Generally, it is not necessary for the PS/2 controller 150 to realize the size of the data from the PS/2 device. In a case that the first byte of the data generated by the PS/2 device is transmitted to the PS/2 controller 150, the PS/2 controller 150 generates an interrupt request IRQ to the south bridge chip 126. In response to the IRQ, the first byte of the data is read by the south bridge chip 126 through the LPC bus.

For example, if six bytes of a data are generated in response to an action of a PS/2 device, the six bytes of the data will be sequentially transmitted from the PS/2 device to the PS/2 controller 150. For each byte, the PS/2 controller 150 generates one IRQ to the south bridge chip 126. In response to the IRQ, the corresponding byte of the data is read by the south bridge chip 126 through the LPC bus. That is, in response to an action of a PS/2 device, the PS/2 controller 150 generates six IRQs. Consequently, the six bytes of the data are sequentially received by the south bridge chip 126 through the LPC bus.

Similarly, if n bytes of a data are generated in response to another action of the PS/2 device, the PS/2 controller 150 needs to generate n IRQs. Consequently, the n bytes of the data are sequentially received by the south bridge chip 126 through the LPC bus.

Please refer to FIG. 1 again. The PS/2 controller 150 is also in communication with a primary PS/2 input port (Pri-PS/2) and an auxiliary PS/2 input port (Aux-PS/2). In a case that a data is inputted into the primary PS/2 input port, the PS/2 controller 150 generates a first interrupt request IRQ1. Whereas, in a case that a data is inputted into the auxiliary input port, the PS/2 controller 150 generates a second interrupt request IRQ2. For example, in response to an action of a keyboard, the data of the keyboard is transmitted to the PS/2 controller 150 through the primary PS/2 input port. Consequently, the PS/2 controller 150 generates the first interrupt request IRQ1 to the south bridge chip 126. According to the first interrupt request IRQ1, the south bridge chip 126 realizes that the data is generated by a keyboard. Whereas, in response to an action of a mouse, the data of the mouse is transmitted to the PS/2 controller 150 through the auxiliary PS/2 input port. Consequently, the PS/2 controller 150 generates the second interrupt request IRQ2 to the south bridge chip 126. According to the second interrupt request IRQ2, the south bridge chip 126 realizes that the data is generated by a mouse.

Generally, it takes about 2 ms for the PS/2 device to generate a byte. Since the speed of the LPC bus is about 33 MHz, the bandwidth of the LPC bus is sufficient for smoothly transferring the data from the PS/2 device. However, since the computer system with ARM (Advanced RISC Machine) architecture or the computer system with other CPU architecture has no LPC bus, the data generated by the PS/2 device fails to be transmitted from the PS/2 controller to the south bridge chip through the LPC bus. Therefore, the PS/2 controller should utilize another bus to efficiently transmit the data that is generated by the PS/2 device.

### SUMMARY OF THE INVENTION

An embodiment of the present invention provides controller. The controller is in communication with a controlling circuit through a bus. The controller includes a first input port, a first buffering unit, a timer, and a package processing unit. The first input port is in communication with a first input device. The first buffering unit is in communication with the first input port for receiving a first byte from the first input device. The timer is in communication with the first input port. When the first byte from the first input device is received by the first buffering unit, the timer starts counting time. If a second byte from the first input device is received by the first buffering unit during a preset time interval, the timer re-counts time. Whereas, if no second byte from the first input device is received by the first buffering unit during the preset time interval, the timer issues a time out signal. In response to the time out signal, all bytes in the first buffering unit are packed into a first packet by the package processing unit and an interrupt request is issues to the controlling circuit.

Another embodiment of the present invention provides controlling method of a controller. The controller is in communication with a controlling circuit through a bus. The controlling method includes the steps of starting counting time when a first byte is received by a first buffering unit of the controller through a first input port, and judging whether a second byte is received by the first buffering unit during a preset time interval. If the second byte is received by the first buffering unit during the preset time interval, the step of counting time is repeatedly. Whereas, if no second byte is received by the first buffering unit during the preset time interval, all bytes in the first buffering unit are packed into a first packet and an interrupt request is issued to the controlling circuit.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating the architecture of a conventional computer system;

FIG. 2 is a schematic functional block diagram illustrating the architecture of a computer system according to an embodiment of the present invention;

FIG. 3 is a functional block diagram illustrating a PS/2 controller according to an embodiment of the present invention; and

FIG. 4 is a flowchart illustrating a controlling method of the PS/2 controller according to an embodiment of the present invention.

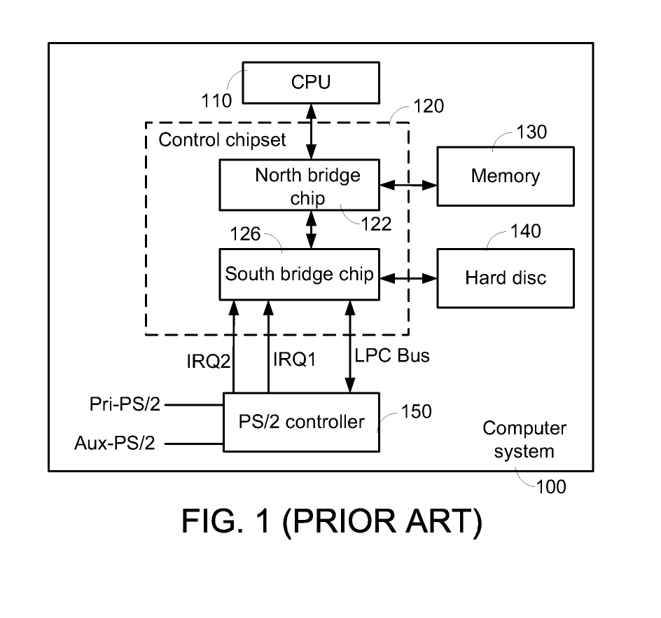

### DETAILED DESCRIPTION OF PREFERRED EMBODIMENTS

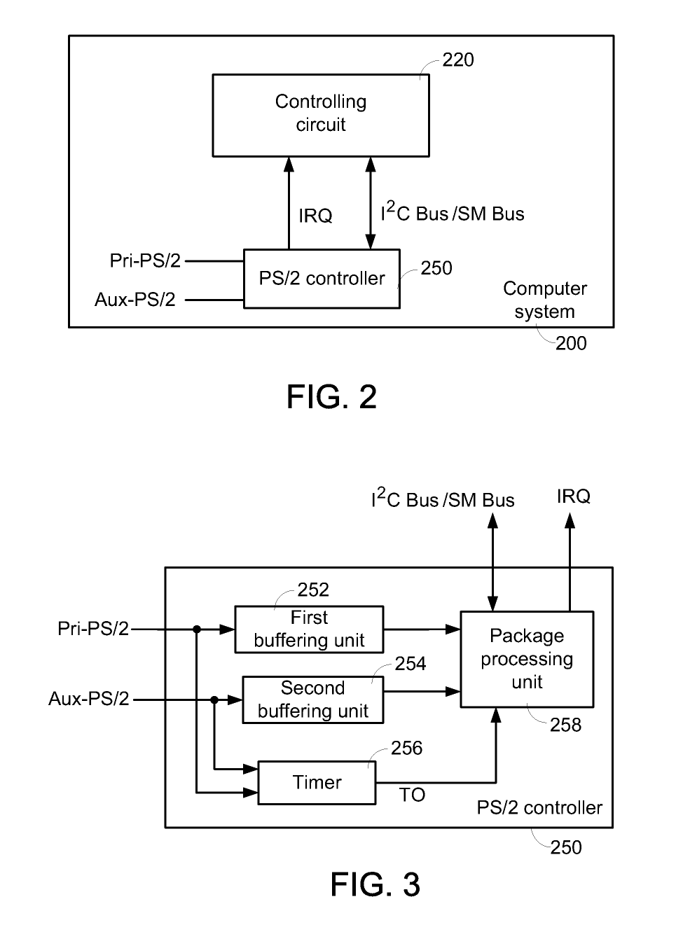

FIG. 2 is a schematic functional block diagram illustrating the architecture of a computer system according to an embodiment of the present invention. As shown in FIG. 2, the computer system 200 comprises a controlling circuit 220 and a PS/2 controller 250. The PS/2 controller 250 is in communication with the controlling circuit 220 through an inter-integrated circuit bus (also referred as an I²C bus) or a system management bus (also referred as a SM bus).

As known, the speed of the I²C bus or the SM bus (e.g. about 100 KHz) is much lower than the speed of the LPC bus (e.g. about 33 MHz). If only one byte of the data is able to be transmitted by the PS/2 controller 250 through the I²C bus or the SM bus at a time, the bandwidth of the I²C bus or the SM bus is readily occupied. Under this circumstance, the data generated by the PS/2 device fails to be effectively transmitted to the controlling circuit 220.

For efficiently utilizing the bandwidth of the I²C bus or the SM bus, the PS/2 controller 250 of the present invention is specially designed. That is, by the PS/2 controller 250, all bytes of the data generated in response to an action of the PS/2 device are firstly converted into a package compliant with the I²C bus specification or the SM bus specification, and then the package is transmitted to the controlling circuit 220. In such way, the bandwidth of the I²C bus or the SM bus can be utilized more efficiently.

Please refer to FIG. 3, which is a functional block diagram illustrating a PS/2 controller according to an embodiment of the present invention. As shown in FIG. 3, the PS/2 controller 250 comprises a first buffering unit 252, a second buffering unit 254, a timer 256, and a package processing unit 258.

The first buffering unit 252 is in communication with a primary PS/2 input port (Pri-PS/2) for receiving the data that is generated by a first PS/2 device (e.g. a keyboard). The second buffering unit 254 is in communication with an auxiliary PS/2 input port (Aux-PS/2) for receiving the data that is generated by a second PS/2 device (e.g. a mouse). The timer 256 is used for counting time. When the first byte of the data is inputted into the first buffering unit 252 or the second buffering unit 254, the timer 256 is reset to re-count time. If the timer value matches a preset time interval, the timer 256 issues a time out signal (TO) to the package processing unit 258. In response to the time out signal, all bytes of the data in the first buffering unit 252 or the second buffering unit 254 are packed into a package by the package processing unit 258. Moreover, the package processing unit 258 issues an interrupt request IRQ to the controlling circuit 220. In response to the IRQ, the package is read by the controlling circuit 220 through the I²C bus or the SM bus.

As previously described, several bytes are generated in response to an action of the PS/2 device, wherein it takes about 2 ms for the PS/2 device to generate one byte. In accordance with the present invention, the timer 256 of the PS/2 controller 250 is used to count time in order to further judge whether all bytes have been outputted from the PS/2 device. In an embodiment, a preset time interval (e.g. 5 ms) is defined by the timer 256. Whenever one byte is received during the preset time interval, the timer 256 re-counts time. The above processes are repeatedly done until no second byte is received during the preset time interval. Under this circumstance, it means that all bytes have been outputted from the PS/2 device.

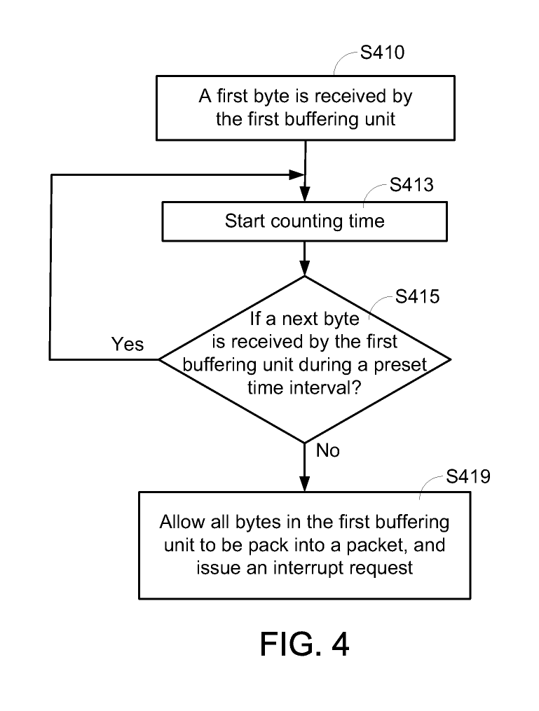

FIG. 4 is a flowchart illustrating a controlling method of the PS/2 controller according to an embodiment of the present invention. Since the operations of the first buffering unit 252 and the second buffering unit 254 substantially identical, only the operations of the first buffering unit 252 are illustrated with reference to FIG. 4. Firstly, when a first byte is received by the first buffering unit 252 (Step S410), the timer 256 starts counting time (Step S413).

Then, the step S415 is performed to judge whether a second byte (or next byte) is received by the first buffering unit 252 during a preset time interval. If a second byte is received by the first buffering unit 252 during the preset time interval, the step S413 is repeatedly done. That is, the timer 256 is reset to re-count time for the preset time interval.

Whereas, if no second byte is received by the first buffering unit 252 during the preset time interval, it means that all bytes have been outputted from the PS/2 device to the first buffering unit 252. Meanwhile, the timer 256 issues a time out signal (TO) to the package processing unit 258. In response to the time out signal, all bytes in the first buffering unit 252 are packed into a package by the package processing unit 258, and an interrupt request IRQ is issued to the controlling circuit 220 (Step S419).

From the above description, the present invention provides a controller and a controlling method thereof. The controller utilizes a timer to judge whether all bytes have been outputted from the PS/2 device. After all bytes from the PS/2 device are temporarily stored in the buffering unit, these bytes are packed into a package by the package processing unit. In addition, the packet containing these bytes is transmitted to the controlling circuit. In such way, the bandwidth of the I²C bus or the SM bus is not usually occupied, and thus the bandwidth of the I²C bus or the SM bus can be efficiently utilized.

In the above embodiment, the controller is illustrated by referring to a PS/2 controller with two PS/2 input ports. Nevertheless, the number of the PS/2 input ports is not restricted. That is, in some other embodiments, the controller may have one PS/2 input port or more than two PS/2 input ports.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A controller in communication with a controlling circuit through a bus, the controller comprising:
a first input port in communication with a first input device;
a first buffering unit in communication with the first input port for receiving a first byte from the first input device;
a timer in communication with the first input port, when the first byte from the first input device is received by the first buffering unit, the timer starts counting time, wherein if a second byte from the first input device is received by the first buffering unit during a preset time interval, the timer re-counts time, wherein if no second byte from the first input device is received by the first buffering unit during the preset time interval, the timer issues a time out signal; and
a package processing unit, wherein in response to the time out signal, all bytes in the first buffering unit are packed into a first packet by the package processing unit and an interrupt request is issues to the controlling circuit.

2. The controller as claimed in claim 1, wherein the bus is an inter-integrated circuit bus or a system management bus.

3. The controller as claimed in claim 1, wherein the first input port is a primary PS/2 input port or an auxiliary PS/2 input port.

4. The controller as claimed in claim 1, further comprising:
a second input port in communication with a second input device; and
a second buffering unit in communication with the second input port for receiving a first byte from the second input device, when the first byte from the second input device is received by the second buffering unit, the timer starts counting time, wherein if a second byte from the second input device is received by the second buffering unit during the preset time interval, the timer re-counts time, wherein if no second byte from the second input device is received by the second buffering unit during the preset time interval, the timer issues the time out signal.

5. A controlling method of a controller, the controller being in communication with a controlling circuit through a bus, the controlling method comprising steps of:
starting counting time when a first byte is received by a first buffering unit of the controller through a first input port; and
judging whether a second byte is received by the first buffering unit during a preset time interval, wherein if the second byte is received by the first buffering unit during the preset time interval, the step of counting time is repeatedly done, wherein if no second byte is received by the first buffering unit during the preset time interval, all bytes in the first buffering unit are packed into a first packet and an interrupt request is issued to the controlling circuit.

6. The controlling method as claimed in claim 5, wherein in response to the interrupt request, the packet is read by the controlling circuit through the bus.

7. The controlling method as claimed in claim 5, wherein the bus is an inter-integrated circuit bus or a system management bus.

8. The controlling method as claimed in claim 5, wherein the first input port is a primary PS/2 input port or an auxiliary PS/2 input port.
